(19) United States
(12) Patent Application Publication
(10) Pub. No.: US 2005/0210689 A1
(43) Pub. Date: Sep. 29, 2005

(54) Reversible doorjamb square

(76) Inventor: William Paul Carroll, Derby, CT (US)

Correspondence Address: William P. Carroll, 1121 South Military Trail, #248, Deerfield Beach, FL, 33442-7645, US

(21) Appl. No.: 10/810,233

(22) Filed: Mar. 27, 2004

(51) Int. Cl. E06B 3/00

(52) U.S. Cl. 33/194

(57) ABSTRACT

The Reversible Doorjamb Square is an improved tool designed as a solid one piece 90-degree right angle square that slides into a plastic lined box beam jamb tube. The invention will allow the user to temporally secure a doorjamb in place before permanently nailing it to the framing members. Adjustments are possible by means of cam levers, calibration screws and stand-off discs that allow the user to position the unit plumb, level, square and flush to the finish wall.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to carpentry tools designed for installing doorjambs.

The object of the invention is to assist the user, to install a doorjamb more accurately than using the age-old standard tool, (Bubble Spirit Level) or any other door jig described in prior art. More specifically the object of the Reversible Doorjamb Square is to produce a perfect 90-degree right angle guide for doorjambs effortlessly every time it is used regardless of weather or not the unit is plumb or level. Contrary to popular belief, a doorjamb can be out of plumb or level, and still fit squarely around the door! Unexpectedly, the Reversible Doorjamb Square can be used to install doorjambs more successfully without the use of bubble spirit levels that are subject to human error. The number one reason why so many people have difficulty installing doorjambs, is over emphasis on bubble spirit leveling devices, rather than squaring devices. The Reversible Doorjamb Square is designed around this concept and produces unexpected consistent results, because of its solid one-piece “90-degree” right angle square and Box Beam Jamb Tube design.

Many doorjambs are installed with difficulty because bubble spirit levels are prone to human error. Prior art describes a horizontal level connected to a vertical level, however a plumb jamb leg and a level head jamb will not always produce a perfectly square 90-degree angle due to aforementioned problems. The Reversible Doorjamb Square solves this problem.

The Reversible Door Jamb Square temporally secures the doorjamb plumb, straight, and square. The jamb is positioned in relation to the finish wall by using adjustable standoff discs.

The idea came to me while living on Nantucket Island. I witnessed many new doors that were installed incorrectly. I decided to design a devise that would assist novice and professionals, to install doors with efficiency and greater accuracy. My original design was complicated with a retractable sliding bracket that did not work. One day while holding my framing square in one hand and my level in the other, I noticed that the framing square almost fit into the end of the level!!! So I trimmed the framing square so that it would fit into the end of a six-foot level. I drilled holes in the level and screwed it to the doorjamb. I forced the framing square to the head jamb to form a perfect right angle.

### DESCRIPTION OF RELATED ART

The related art describes many devices used to align doorjambs. U.S. Pat. No. 6,442,853 Issued to Hale improperly describes two bubble spirit levels connected to form an L-shaped leveling device described as a square. The connection between the two extensions can move due to the length and leverage imposed on said connection. A deviation of any degree renders the description (right angle square) inaccurate. Furthermore the age-old problem still exits. Using this devise depends on reading bubble spirit levels prone to human error. U.S. Pat. No. 5,813,125 issued to Byrn describes a hands free square that can be mounted to the work piece with screws. U.S. Pat. No. 4,910,876 issued to Channell describes a devise that attaches to an ordinary I-Beam Spirit Level to form a right angle. U.S. Pat. No. 2,636,282 issued to Kronquist describes a door frame setting gauge enabling workman to quickly and accurately install doorjambs. The inverted L shaped gauge is fastened to the jamb using finish nails. U.S. Pat. No. 2,973,584 issued to Snapp is another devise less cumbersome to store and transport. It will adjust for angles greater than 90-degrees. U.S. Pat. No. 2,748,493 issued to Williams describes a door jig mechanism for installing doorframes. This devise has two vertical extensions and two horizontal extensions. The diagonal section is used to keep the unit square. Web plates extend past the doorjamb. Holes are provided to allow screws to hold the web plates against the finish wall.

Improvements that are needed for a devise to work properly are described as follows: A solid one piece 90-degree right angle square that can be held in place along the vertical blade of said square, by a long extension Box Beam Jamb Tube. Calibration provided by setscrews. Solid 90-degree right angle squares that are reversible with different blade lengths to accommodate different door sizes. Cam levers, to provide quick connection of said right angles. Standoff discs located in the flange blocks and plates that will allow the devise to float between the rough opening.

None of the inventions or patents taken either singularly or in combination is seen to describe the invention claimed. Thus a solid one-piece reversible doorjamb square (with calibration and quick connections, with vertical box beam, flange plates and standoff discs) for solving the aforementioned problems are desirable.

### SUMMARY OF THE INVENTION

The Reversible Doorjamb Square is a solid one-piece 90-degree right angle square that slides into a nylon lined box beam vertical extension tube. It is held in place between cam levers and calibration screws. The unit is used to temporally support and align the doorjamb in its desired location. The devise can position the doorjamb straight, plumb, square, and flush all at once while the installers hands are free to permanently fasten without umpteen decisions and unnecessary adjustments. Other doorjamb devises use bubble spirit levels as a method to produce a 90-degree right angle. Attempting to produce a perfect 90-degree right angle in this fashion is not impossible, although difficult because bubble levels are subject to human error and interpretation.

### DISCRIPTION OF DRAWINGS

FIG. 1. is a fully assembled perspective view of the Reversible Doorjamb Square according to the present invention. The right angle I-beam Square is inserted into the body of the box beam jamb tube and the flange blocks are mounted.

FIG. 2. is a front perspective view of the cam lever, casting and calibration screws with pin.

FIG. 2A. is a cross section view of the cam lever, casting, calibration screws and pin.

FIG. 3. is a side perspective view of the flange block, right angle I-beam, standoff discs, with knob and adjustment screws, slotted T-bolt adjustment screw and knob according to the present invention.

FIG. 4. is a cross section view illustrating the right angle I-beam inside the box beam jamb tube and nylon liner. The cam levers are open in the binding position. The calibration screws and cam levers and pins are also illustrated.

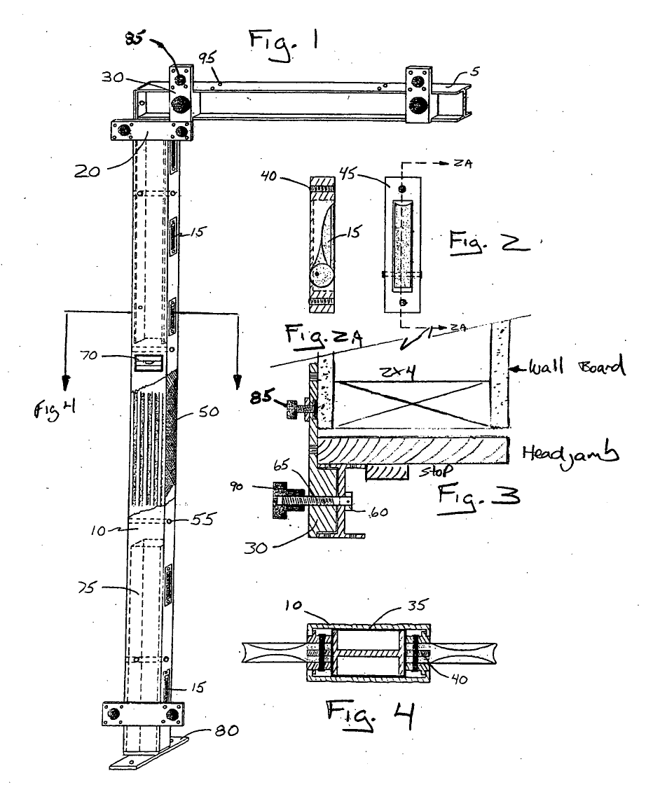

### DETAILED DESCRIPTION OF THE INVENTION

This invention is a special tool used for installing doorjambs perfectly straight, plumb, square and flush with the surface of the finish wall. The invention would be technically described as a right angle I-Beam 5 that slides into a rectangular metal (plastic lined 35) box beam 10 that locks into place at 90-degrees using cam levers 15 and calibration screws. 40 Both the right angle I-beam 5 and the box beam 10 have plates 20 and flange blocks 30 equipped with adjustable stand-off discs 25 that allow positioning the doorjamb in the middle of the wall. Flange plates 20 and flange blocks 30 have adjustable knobs. 85 The flange blocks 30 have swivel tees 60 and slotted threaded rods 65 for quick fastening using the adjustment knob 90

The right angle I-beam 5 is designed to be screwed to the head jamb thru holes 95 keeping it straight and more importantly at 90-degrees in relation to the hinged side of the doorjamb.

The right angle I-beam 5 shall be made from cast aluminum and will be pre-drilled to allow the use of removable flange blocks 30 The right angle I-beam 5 is held in position by cam levers 15 and calibration screws 40 located within the casting. 45 The cam lever housing 45 will be cast and mounted flush to the edge of the box beam jamb tube. 10 The cam levers 15 will hold the right angle I-beam 5 against opposing calibration screws. 40 The calibration screws 40 are located in the cam lever housing. 45

The box beam jamb tube 10 is made from aluminum or metal and shall be machined on each edge. 50 Mounting holes and sleeves 55 will allow the screws to go thru the box beam 10 and into the doorjamb keeping it straight. Inside the box beam jamb tube 10 will be a nylon liner 35 to allow the right angle I-beam 5 to slide smoothly in and out of the box beam jamb tube. 10

The box beam jamb tube 10 will have a bubble spirit level 70 to assist the user to mount the unit plumb.

The bottom of the box beam jamb tube will have a telescopic extension leg 75 and floor mounting plate. 80

1. (canceled)

2. (canceled)

3. (canceled)

4. A reversible, attachable, adjustable in length and width, one piece 90 degree right angle square connected to a rectangular sleeve, box beam extension tube comprising:
(a). a one piece 90 degree right angle square having an I-beam cross section having first and second ends of different lengths.
(b) a hollow sleeve, box beam extension tube with top and bottom ends with face and edges that are rectangular to each other, and slightly larger than the I-Beam cross section of the 90 degree right angle I-beam square mentioned in (a) allowing either end of said 90 degree I-Beam square to be inserted down through the top end of said box beam extension tube and secured by means of friction and pressure forcing the inserted length of I-beam parallel, in relation to the sleeve shaped box beam extension tube thus forming a perfect 90 degree right angle extension square used for squaring doorjambs.

5. The method of combining by inserting and securing said one piece 90 degree right angle I-Beam square mentioned in claim 4a, into the top end of a rectangular sleeved shaped box beam extension tube mentioned in claim 4b in order to form an extended 90 degree right angle square that is reversible, adjustable in length and width by use of a various length, 90 degree right angle square.
